(19) United States
(12) Patent Application Publication
(10) Pub. No.: US 2018/0327988 A1
(43) Pub. Date: Nov. 15, 2018

(54) Double-Handle Snow Shovel

(71) Applicant: Peter J. Ziamandanis, Loudonville, NY (US)

(72) Inventor: Peter J. Ziamandanis, Loudonville, NY (US)

(21) Appl. No.: 16/042,291

(22) Filed: Jul. 23, 2018

Related U.S. Application Data
(63) Continuation-in-part of application No. 29/599,811, filed on Apr. 6, 2017, now Pat. No. D823656.
(60) Provisional application No. 62/630,933, filed on Feb. 15, 2018.

(51) Int. Cl. E01H 5/02

(52) U.S. Cl. CPC E01H 5/02; A01B 1/026

(57) ABSTRACT

A double-handle snow shovel includes a scoop, a support shaft, a bend shaft, and a handle as the support shaft and the bend shaft are collectively optimize leverage for lifting, throwing, and removing snow. The bend shaft includes a first elongated section, a second elongated section, and a bend section as the bend handle is formed into a V-shaped body. The first elongated section is terminally connected to a first shaft end of the support shaft. The second elongated section is terminally connected to a second shaft end of the support shaft. The first and second elongated section are terminally connected to each other by the bend section, opposite of the support shaft. The first shaft end is concentrically mounted within a collar of the scoop that removes snow. The second shaft end is concentrically connected within a connector section of the handle that engages with the user's hand.

The current application is a continuation-in-part (CIP) application of the U.S. design application Ser. No. 29/599,811 files on Apr. 6, 2017.

The current application also claims a priority to a U.S. provisional application Ser. No. 62/630,933 filed on Feb. 15, 2018.

### FIELD OF THE INVENTION

The present invention relates generally to a shovel. More specifically, the present invention is a double-handle snow shovel that enables a user to remove snow accumulations without having to bend over to place the shovel against the ground surface.

### BACKGROUND OF THE INVENTION

Every winter, cities around the world are covered in snow. While children may enjoy making snowmen and having snowball fights, adults need to remove snow from their properties in order to drive and function in daily life. Snow comes in a variety of forms that occasionally makes it very difficult for the user to remove. Particularly when it rains before snowing, the resulting agglomerations of wet snow are heavy and difficult to move. To this end, a variety of shovels and plows have been developed to remove the snow. However, snow plows can be expensive, and necessarily require fuel or attachment vehicles. Snow blowers too can be pricy and difficult to store in many garages. Standard shovels can cause injuries due to awkward usage. Shovels generally just have one handle and one support connected to the head. The user is meant to grasp the handle with one hand and grasp the support with the other hand. The design of almost all shovels requires the operator to use the shovel while bending over, which is not conducive to protecting the user's back. Resultantly, there is a need for a device that is easy to use and maintain, while simultaneously ensuring there is no related stress to the user's back. What is further needed is a device that enables the user to support the shovel with both hands while standing in a complete upright position.

It is therefore an object of the present invention to provide a double-handle snow shovel that provide two places for gripping. The first handle is positioned similar to the existing handle position of most shovels. The second handle is a bent handle that forms a V-shaped body. The second handle has two ancillary supports located proximally connected to the first handle as the two ancillary supports are connected to each other by a bend section. The section handle enables the user to grasp the snow shovel from two gripping positions (two ancillary supports), thus allowing the user to utilize the present invention without bending over at the waist or spine to pick up and throw snow. An upright position prevents the user from worrying about damage to the user's back or body during use, while further allowing optimal leverage for lifting and subsequently removing snow.

### BRIEF DESCRIPTION OF THE DRAWINGS

FIG. 1 is a front perspective view of the present invention.

FIG. 2 is a rear perspective view of the present invention.

FIG. 3 is a front view of the present invention, showing a detailed view of the scoop.

FIG. 4 is a side view of the present invention, wherein the support shaft is a straight body.

FIG. 5 is a side view of the present invention, wherein the support shaft is a curved body.

FIG. 6 is a side view of the present invention, showing the acute angle between the first elongated section and the second elongated section, the length of the first elongated section, and the length of the second elongated section.

### DETAIL DESCRIPTIONS OF THE INVENTION

All illustrations of the drawings are for the purpose of describing selected versions of the present invention and are not intended to limit the scope or spirit of the present invention.

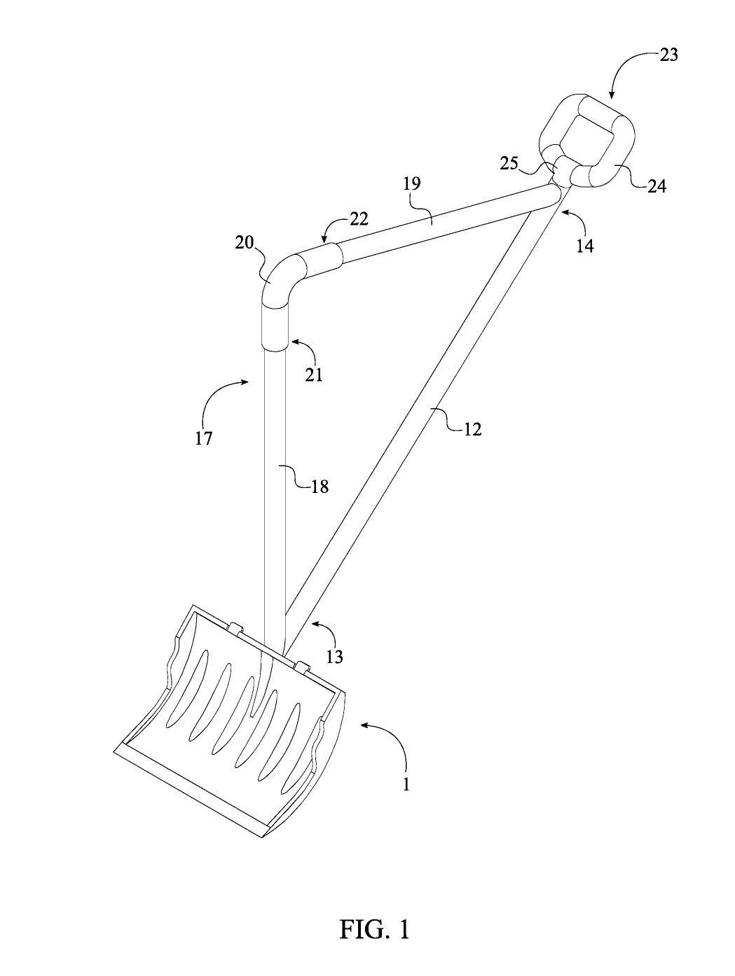

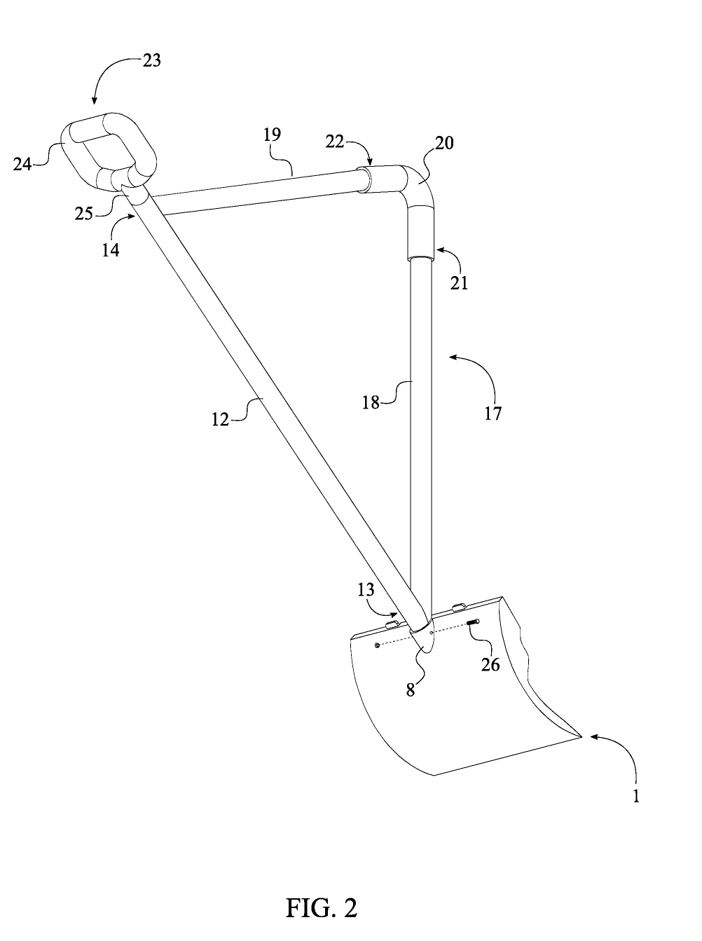

The present invention is a snow shovel that enables the user to remove accumulated snow from the ground after a snowfall. The components and their configuration of the present invention enable the user to remove snow without having to bend over at the waist or body during usage. The present invention comprises a scoop 1, a support shaft 12, a bend shaft 17, a handle 23 as shown in FIG. 1. The bend shaft 17 enables the user to keep a straight back during usage and comprises a first elongated section 18, a second elongated section 19, and a bend section 20. In reference to the general configuration of the present invention as shown in FIG. 1-2, the support shaft 12 and the bend shaft 17 are connected to each other delineating a triangular profile. The scoop 1 is terminally connected to the support shaft 12 from one end. The handle 23 is terminally connected to the support shaft 12 and positioned opposite of the scoop 1 thus completing the present invention.

The support shaft 12 functions as the base member within the present invention as the support shaft 12 allows the scoop 1 and the handle 23 to be mounted. Furthermore, the support shaft 12 stabilizes the bend shaft 17 and eliminates any elastic deformation that can occur due the weight of the snow. The bend shaft 17 allows the user to grasp the present invention during usage so that the user can maintain a straight back. In reference to FIG. 1-2, the first elongated section 18 is terminally connected to a first shaft end 13 of the support shaft 12 so that the bend shaft 17 can be connected from one end. The second elongated section 19 is terminally connected to a second shaft end 14 of the support shaft 12 so that the bend shaft 17 can be connected from the opposite end. The bend section 20 is then able to connect the first elongated section 18 and the second elongated section 19 thus completing the overall structure between the support shaft 12 and the bend shaft 17. More specifically, the first elongated section 18 is terminally connected to a first end 21 of the bend section 20, opposite of the first shaft end 13. The second elongated section 19 is terminally connected to a second end 22 of the bend section 20, opposite of the second shaft end 14. Resultantly, the support shaft 12 and the bend shaft 17 are able to complete the triangular profile of the present invention while the bend section 20, the first shaft end 13, and the second shaft end 14 delineate the angles of the triangular profile.

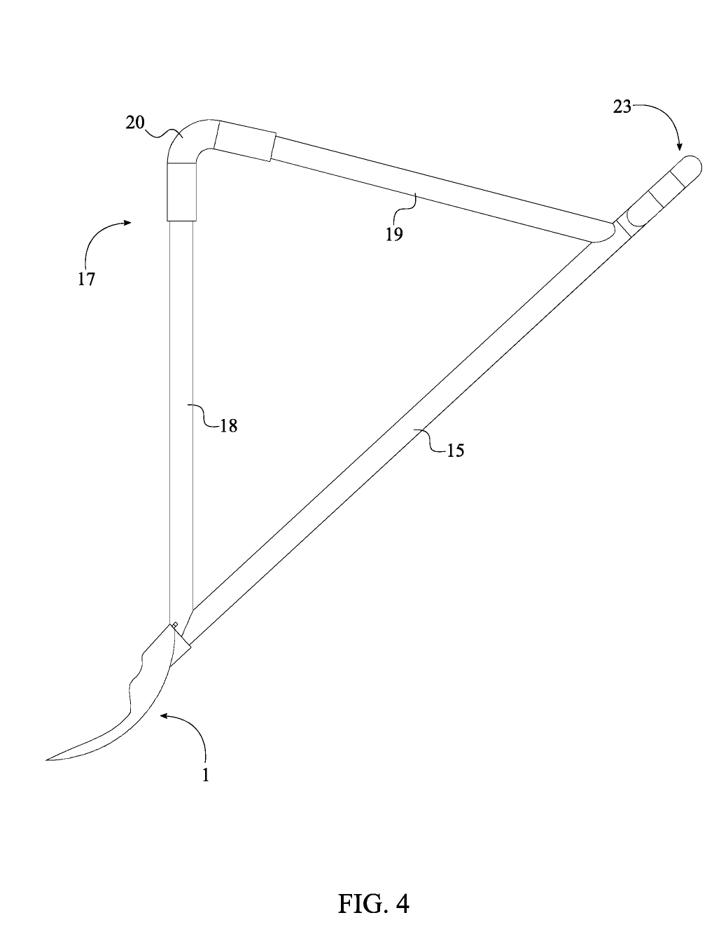

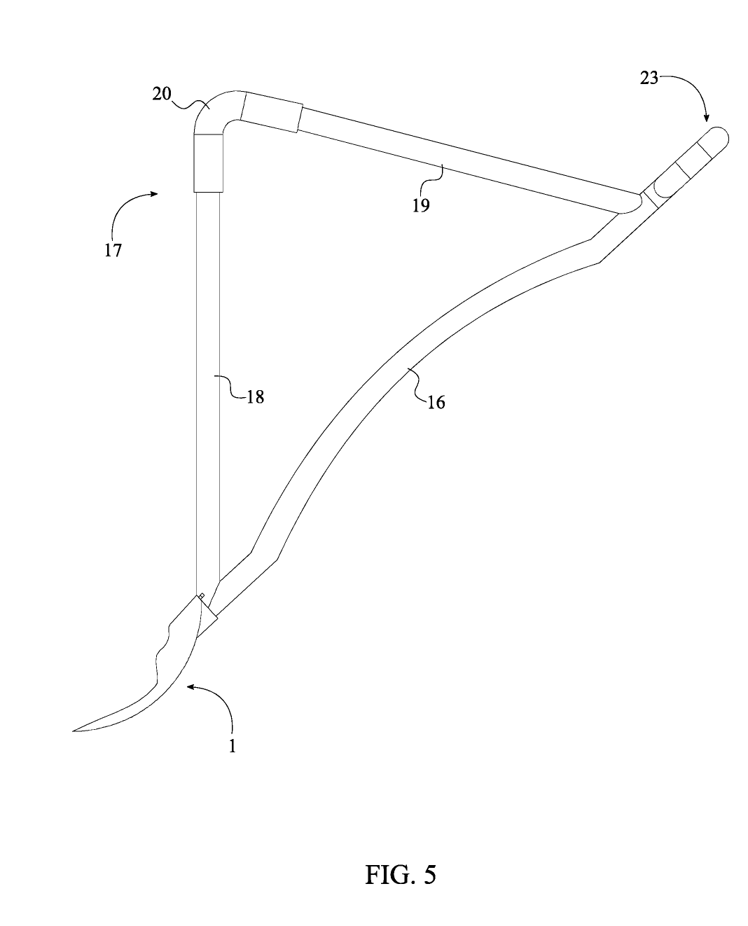

In one embodiment of the present invention, the support shaft 12 can be a straight body 15 from the first shaft end 13 to the second shaft end 14 as shown in FIG. 4. In another embodiment of the present invention, the support shaft 12 can be a curved body 16 from the first shaft end 13 to the second shaft end 14 as shown in FIG. 5. Furthermore, a convex side of the curved body 16 is oriented towards the bend shaft 17. The straight body 15 and the curved body 16 provide an aesthetical difference between each embodiment. However, both the straight body 15 and the curved body 16 maintain the same structural integrity within the present invention to eliminate any elastic deformation that may otherwise occur within the bend shaft 17.

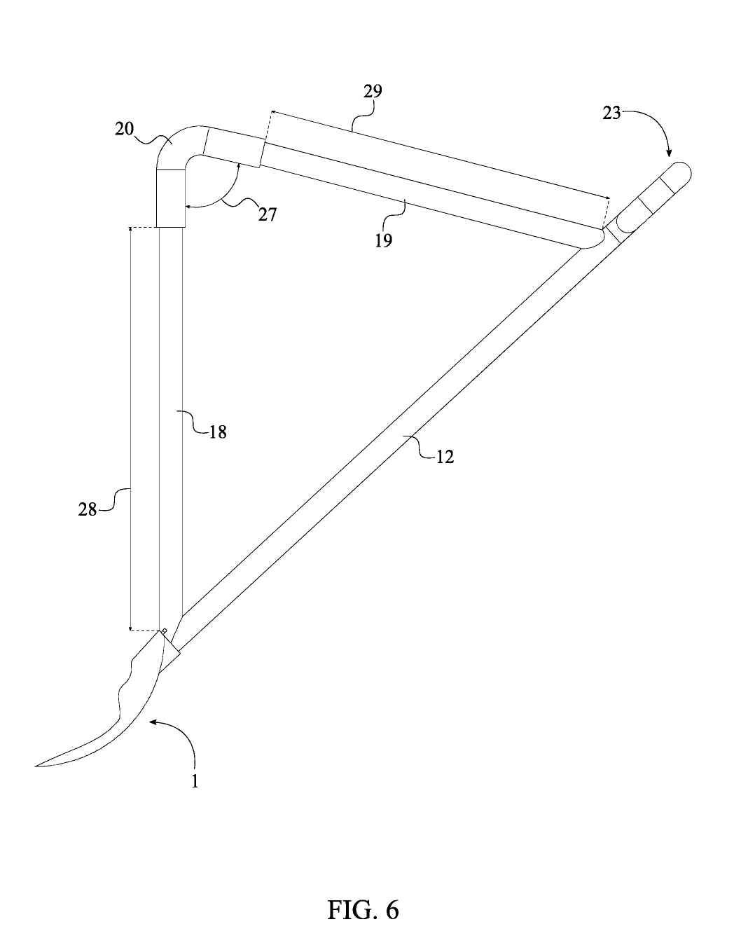

In reference to FIG. 6, the first elongated section 18 and the second elongated section 19 delineate an acute angle 27 about the bend section 20. Preferably, the acute angle 27 can be measured about 77 degrees within the present invention. In reference to FIG. 6, a length 28 of the first elongated section 18 is greater than a length 29 of the second elongated section 19. Collectively, the acute angle 27 and the length difference between the first elongated section 18 and the second elongated section 19 position the bend section 20 above the second shaft end 14. As a result, the user can comfortably grasp the handle 23 and the bend section 20 during the usage of the present invention without having to bend down. In other words, the user can grasp the handle 23 with one hand thus partially securing the present invention. The user can then fully secure the present invention by grasping the bend section 20 with the other hand. Since the bend section 20 is positioned above the second shaft end 14, the user can simply extend their arm and grasp the bend section 20 without having to bend down, all while the shovel scoop is touching the ground.

In reference to FIG. 2, the first shaft end 13 is concentrically mounted within a collar 8 of the scoop 1 so that the support shaft 12 and the scoop 1 can be secured within the present invention. More specifically, the collar 8 and the first shaft end 13 are mounted to each other by a fastener 26 so that the scoop 1 can be detached when necessary. As a result, the first shaft end 13 can be interchanged with multiple scoop is that are different in width, different in shape, or different in material. Additionally, when an old scoop is worn out and unusable, the worn-out scoop can be changed into a new scoop with the fastener 26. The fastener 26 can include, but is not limited to, a screw fastener, a male and female treaded fastener, a clamp fastener, a snap fastener, and a latch fastener.

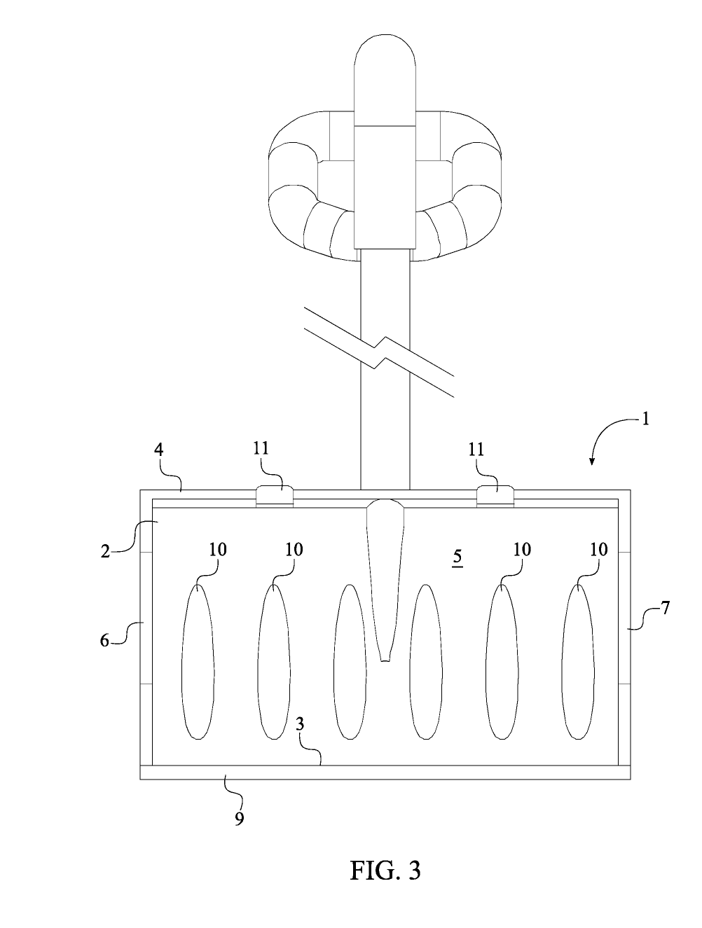

The scoop 1 functions similar to existing shovel heads so that snow can be collected within the present invention. In reference to FIG. 3, the scoop 1 further comprises a blade 2, a first lateral wall 6, a second lateral wall 7, a scraper edge 9 in addition to the collar 8. The collar 8 is a cylindrical sleeve body and adjacently connected to a rear edge 4 of the blade 2 so that the support shaft 12 can be inserted into the collar 8. The scraper edge 9 is a shape/rigid body, preferably metal reinforced edge, so that the user can easily brake or chop ice or dig into the snow. The scraper edge 9 is adjacently connected to a front edge 3 of the blade 2 so that the scraper edge 9 can provide the initial contact with snow during usage of the present invention. As a result, the scraper edge 9 and the collar 8 are oppositely positioned of each other about the blade 2 as the snow is generally pushed forward by the user. The first lateral wall 6 is terminally connected along the blade 2 to prevent snow from falling off the side of the blade 2. The second lateral wall 7 is terminally connected along the blade 2 and positioned opposite of the first lateral wall 6 to prevent snow from falling off the opposite side of the blade 2. More specifically, the first lateral wall 6 and the second lateral wall 7 are extended from the rear edge 4 to the front edge 3 so that the arrangement of the first lateral wall 6 and the second lateral wall 7 enable the user to keep snow atop the blade 2.

In reference to FIG. 3, the scoop 1 further comprises a plurality of grooves 10 as the plurality of grooves 10 is linearly extended along an inner surface 5 of the blade 2. The plurality of grooves 10 is a set of channels that is generally arranged in a linear pattern extending along the blade 2 so that the snow can break apart and contain within the scoop 1 from sliding to one side or the other side during use. In other words, the plurality of grooves 10 is extended vertically from the front edge 3 of the scoop 1 to the rear edge 4 of the scoop 1 as each of the plurality of grooves 10 is equally spaced apart from each other in between the first lateral wall 6 and the second lateral wall 7.

In reference to FIG. 3, the scoop 1 further comprises a pair of stacking supports 11 so that the present invention can store within a limited amount of space for convenience by offsetting them from each other. More specifically, the pair of stacking supports 11 is connected along the rear edge 4 as the collar 8 is symmetrically positioned in between the pair of stacking supports 11. As a result, the user can arrange multiple embodiments of the present invention to the right side and the left side of the first embodiment, thus efficiently maximizing the space.

In reference to FIG. 1-2, the second shaft end 14 is concentrically connected within a connector section 25 of the handle 23 so that the support shaft 12 and the handle 23 can be secured within the present invention. The handle 23 further comprises a gripping section 24 in addition to the connector section 25 as the gripping section 24 and the connector section 25 are adjacently connected to each other. More specifically, the gripping section 24 provides ergonomic and smooth surface area to grasp the handle 23 as the connector section 25 is terminally connected extended from the gripping section 24. The connector section 25 is a cylindrical sleeve body and allows the second shaft end 14 to be inserted thus completing the connections between the support shaft 12 and the handle 23.

The present invention may further comprise a grip to enhance the friction between the user's hand and the bend section 20. The grip is a generally flexible, preferably rubber or foam extrusion that wraps around the bend section 20 or near that general area.

Although the invention has been explained in relation to its preferred embodiment, it is to be understood that many other possible modifications and variations can be made without departing from the spirit and scope of the invention as hereinafter claimed.

What is claimed is:

1. A double-handle snow shovel comprises:
a scoop;
a support shaft;
a bend shaft;
a handle;
the bend shaft comprises a first elongated section, a second elongated section, and a bend section;
the first elongated section being terminally connected to a first shaft end of the support shaft;
the second elongated section being terminally connected to a second shaft end of the support shaft;
the first elongated section being terminally connected to a first end of the bend section, opposite of the first shaft end;
the second elongated section being terminally connected a second end of the bend section, opposite of the second shaft end;
the first shaft end being concentrically mounted within a collar of the scoop; and
the second shaft end being concentrically connected within a connector section of the handle.

2. The double-handle snow shovel as claimed in claim 1 comprises:
the scoop further comprises a blade, first lateral wall, a second lateral wall, and a scraper edge;
the collar being adjacently connected to a rear edge of the blade;
the scraper edge being adjacently connected to a front edge of the blade;
the scraper edge and the collar being oppositely positioned of each other about the blade;
the first lateral wall being terminally connected along the blade;
the second lateral wall being terminally connected along the blade, opposite of the first lateral wall; and
the first lateral wall and the second lateral wall being extend from the rear edge to the front edge.

3. The double-handle snow shovel as claimed in claim 1 comprises:
the scoop further comprises a plurality of grooves; and
the plurality of grooves being linearly extended along an inner surface of the blade.

4. The double-handle snow shovel as claimed in claim 1 comprises:
the scoop further comprises a pair of stacking supports;
the pair of stacking supports being connected along a rear edge of the blade; and
the collar being symmetrically positioned in between the pair of stacking supports.

5. The double-handle snow shovel as claimed in claim 1 comprises:
a fastener; and
the collar and the first shaft end being mounted to each other by the fastener.

6. The double-handle snow shovel as claimed in claim 1 comprises:
the handle further comprises a gripping section; and
the gripping section and the connector section being adjacently connected to each other.

7. The double-handle snow shovel as claimed in claim 1, wherein the support shaft is a straight body.

8. The double-handle snow shovel as claimed in claim 1, wherein the support shaft is a curved body.

9. The double-handle snow shovel as claimed in claim 1, wherein the first elongated section and the second elongated section delineate an acute angle about the bend section.

10. The double-handle snow shovel as claimed in claim 1, wherein a length of the first elongated section being greater than a length of the second elongated section.

11. A double-handle snow shovel comprises:
a scoop;
a support shaft;
a bend shaft;
a handle;
a pair of stacking supports;
the bend shaft comprises a first elongated section, a second elongated section, and a bend section;
the first elongated section being terminally connected to a first shaft end of the support shaft;
the second elongated section being terminally connected to a second shaft end of the support shaft;
the first elongated section being terminally connected to a first end of the bend section, opposite of the first shaft end;
the second elongated section being terminally connected a second end of the bend section, opposite of the second shaft end;
an acute angle being delineated between the first elongated section and the second elongated section about the bend section.
the first shaft end being concentrically mounted within a collar of the scoop;
the second shaft end being concentrically connected within a connector section of the handle;
the pair of stacking supports being connected along a rear edge of the blade; and
the collar being symmetrically positioned in between the pair of stacking supports.

12. The double-handle snow shovel as claimed in claim 11 comprises:
the scoop further comprises a blade, first lateral wall, a second lateral wall, and a scraper edge;
the collar being adjacently connected to the rear edge of the blade;
the scraper edge being adjacently connected to a front edge of the blade;
the scraper edge and the collar being oppositely positioned of each other about the blade;
the first lateral wall being terminally connected along the blade;
the second lateral wall being terminally connected along the blade, opposite of the first lateral wall; and
the first lateral wall and the second lateral wall being extend from the rear edge to the front edge.

13. The double-handle snow shovel as claimed in claim 11 comprises:
the scoop further comprises a plurality of grooves; and
the plurality of grooves being linearly extended along an inner surface of the blade.

14. The double-handle snow shovel as claimed in claim 11 comprises:
a fastener; and
the collar and the first shaft end being mounted to each other by the fastener.

15. The double-handle snow shovel as claimed in claim 11 comprises:
the handle further comprises a gripping section; and
the gripping section and the connector section being adjacently connected to each other.

16. The double-handle snow shovel as claimed in claim 11, wherein the support shaft is a straight body.

17. The double-handle snow shovel as claimed in claim 11, wherein the support shaft is a curved body.

18. The double-handle snow shovel as claimed in claim 11, wherein a length of the first elongated section being greater than a length of the second elongated section.
